(19) United States
(12) Patent Application Publication
(10) Pub. No.: US 2020/0391958 A1
(43) Pub. Date: Dec. 17, 2020

(54) ORIENTATION SYSTEM FOR PRODUCT CONVEYORS

(71) Applicant: AVANCON SA, Riazzino (CH)

(72) Inventor: Dieter Specht, Arcegno (CH)

(21) Appl. No.: 16/970,926

(22) PCT Filed: Feb. 7, 2019
(86) PCT No.: PCT/IB2019/050989

§ 371 Date: Aug. 18, 2020

(30) Foreign Application Priority Data
Mar. 1, 2018 (IT) 102018000003165

(51) Int. Cl. B65G 47/24; B65G 13/10

(52) U.S. Cl. CPC B65G 47/24; B65G 2811/0626; B65G 13/10

(57) ABSTRACT

An orientation system for conveyors of products designed to divert the latter from a primary feed direction to a secondary feed direction and comprising a plurality of orienting units. Each orienting unit comprises a transporting element rotatable around a rotation axis and an actuating member to actuate the rotation of at least one transporting element so as to control the rotation of a transporting element. The actuating member comprises a primary transmission element and a planet transmission element designed to be coupled to the primary transmission element; at least two housing seats for respective planet transmission elements being designed to transmit the rotation motion of the transporting element to an adjacent orienting unit.

### FIELD OF THE INVENTION

The present invention relates to an orientation system for product conveyors. In particular, the present invention relates to an orientation system for product conveyors for orienting and then displacing products from a primary direction to one or more secondary directions. Clearly, products require to be conveyed from a primary direction to one or more secondary directions due to the fact that not all products are of the same type or have the same final destination.

### KNOWN ART

At the state of the art, several applications are known for transporting and conveying systems to transport and convey products from a primary direction to one or more secondary directions, such as for example in post offices, airports and in large goods sorting hubs of the greatest shipping companies. By way of example, a transfer assembly for conveyor systems is illustrated in document WO2015121786.

### SUMMARY OF THE INVENTION

Today there are increasingly numerous requests for sorting and conveying products due to the fact that there are more and more characteristics for grouping products (i.e. collecting products with common characteristics): weight, overall dimensions, product type, commercial value of the product, perishability or non-perishability of the product, urgency of delivery to the final receiver and so on.

Due to the high number of grouping characteristics, even transport systems became over time more and more complex, sophisticated and especially of large dimensions. Large dimensions do not necessarily mean an absolute measure of the system but increased demands for space to house components that together make the system of large dimensions compared to the surface on which products transit and are conveyed. Just consider, for example, that a secondary conveying direction of products in the whole system could become in turn a new primary conveying direction of products, by virtue of the foregoing.

Therefore, it is recognized that the dimensions of the system and the space its components take up are in practice one of the main limitations that can be highlighted with reference to transport/conveying systems of known type.

A second limitation of the transferring systems or assemblies to transfer products is the restricted modularity they have in deviating/conveying the products from a primary direction and/or zone to a secondary direction and/or zone or restricted modularity interpreted as the ability of known systems to manage different types of products while having the same basic structure and design of the system itself.

### BRIEF DESCRIPTION OF THE DRAWINGS

The description of the present invention is provided with reference to the accompanying figures, also having a purely exemplifying and therefore not limiting purpose and in which:

FIG. 1 is a schematic plan view of the orientation system for product conveyors according to the present invention;

FIG. 2 is a schematic perspective sectional view of the system of FIG. 1 with some hidden parts in order to better highlight other parts;

FIG. 3 is a schematic perspective exploded view of the system of FIG. 2;

FIG. 4 is a schematic perspective view of the orientation system of FIG. 1 with some hidden parts in order to better highlight other parts; and

FIG. 5 shows a plane P consisting of a plurality of orienting units 10, 10′, according to the present invention.

### DETAILED DESCRIPTION OF EMBODIMENTS OF THE INVENTION

The present invention relates to an orientation system for product conveyors, the system being designed to divert said products from a primary feed direction F to a secondary feed direction M, N or N′.

In particular, the present invention comprises a plurality of orienting units arranged adjacent so as to form a plane for transporting products. According to the present invention, unless otherwise specified in the present description, adjacent orienting unit means a unit arranged sideways, to the right and/or left side of a predetermined orienting unit.

According to the present invention, each orienting unit comprises at least one transporting element rotatable around a rotation axis X which can be oriented with respect to a vertical axis Z orthogonal to the afore said primary feed direction F and the rotation axis X itself.

In particular, each orienting unit comprises at least one actuating member to actuate the rotation of at least one transporting element in order to control the rotation thereof around the rotation axis X and at least one drive shaft arranged according to the aforesaid vertical axis Z.

According to the inventive concept of the present invention, at least one orienting unit is a driving orienting unit designed to rotate its own rotation axis X and, through the actuating member, also rotate the rotation axis X of at least one orienting unit preferably laterally adjacent thereto. In more detail, the rotation axis X of at least one orienting unit can be oriented independently of respective orientable rotation axes X of other laterally-adjacent orienting units.

The aforesaid actuating member is modular so as to allow a predetermined number of adjacent orienting units to be selectively actuated. The actuating member is designed to reversibly activate and rotate/stop one or more transporting elements of the predetermined adjacent orienting units.

According to the inventive concept of the present invention, the actuating member advantageously comprises at least one primary transmission element keyed on the drive shaft. Furthermore, the actuating member comprises at least one planet transmission element designed to be operatively coupled to the primary transmission element.

In addition, the actuating member comprises at least two housing seats for at least one planet transmission element which is designed to be selectively and reversibly coupled into at least one of the housing seats so as to transmit the rotation motion of the transporting element to a primary transmission element of an adjacent orienting unit.

The actuating member is such as to comprise a gear assembly, the primary transmission element and the planet transmission element. The aforesaid gear assembly is operatively combined between the orienting unit and respective adjacent orienting units. The primary transmission element further comprises at least one primary gear while the planet transmission element comprises at least one planet gear. The aforesaid planet gear is operatively combined with the primary gear of an orienting unit and is designed to mesh with a respective planet gear of an adjacent orienting unit so as to mechanically connect the drive shaft of the orienting unit to the drive shaft of the adjacent unit.

Preferably, the gear assembly of the actuation member comprises a planet gear per each adjacent orienting unit.

In particular, the two seats are arranged parallel to a rotation plane R orthogonal to the vertical axis Z.

Even in more detail, the gears of the gear assembly are at least partially housed inside a box-like structure of the orienting unit and are operatively arranged parallel to the rotation plane R.

Furthermore, the gears of the gear assembly each lie on their own rotation plane. Preferably, the rotation plane of each gear is parallel to the rotation plane R.

According to the present invention, the movement means are designed to rotate in a controlled manner the rotation axis X of one or more orienting units.

The aforesaid movement means comprise at least one electric motor and one rack system for transmitting the rotation movement of the motor to a sleeve element operatively combined with the drive shaft of each orienting unit.

The sleeve element is operatively combined with a supporting element of the transporting element so as to determine the angular orientation of the axis X with respect to the vertical axis Z.

The actuating member is designed to modulate the speed and/or gear ratio of the rotation around the axis of one or more transporting elements of respective adjacent orienting units.

In particular, the system of the present invention comprises a plurality of orienting units arranged along the transport plane P according to a matrix scheme, the matrix consisting of rows/columns so that each orienting unit has an even and/or odd number of adjacent orienting units. For example, sideways to an orienting unit there may be only another one adjacent orienting unit, or there may be two other adjacent orienting units.

According to the present invention, the orienting units are arranged according to a single column and a predetermined number of rows. Preferably, the column-shaped orienting units are marginally arranged with respect to a predominant feed direction of products.

Preferably, there are four housing seats per each orienting unit.

Each housing seat is arranged on a respective side of an orienting unit. Preferably, two housing seats are arranged along the primary feed direction F and two housing seats are arranged along a direction perpendicular to the primary feed direction F.

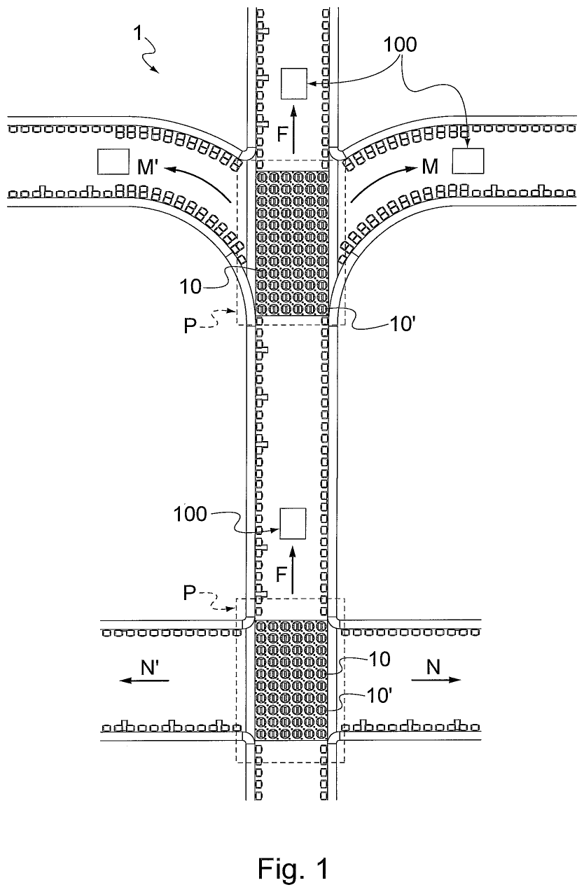

Below, with reference to the accompanying FIGS. 1-4, there is a detailed description of the present invention, concerning an orientation system 1 for conveyors of products 100, the system being designed to divert the products from a primary feed direction F to a secondary feed direction. By way of non-limiting example, in the appended FIG. 1 the secondary directions M, N and N′ and obviously the above-mentioned primary direction F are illustrated.

In detail, the system 1 of the present invention comprises a plurality of orienting units 10, 10′ arranged adjacent to form a plane P for transporting said products 100. Each orienting unit 10, 10′ comprises at least one transporting element 11 rotatable around a rotation axis X which can be oriented with respect to a vertical axis Z orthogonal to both the primary feed direction F and, at the same time, the rotation axis X itself.

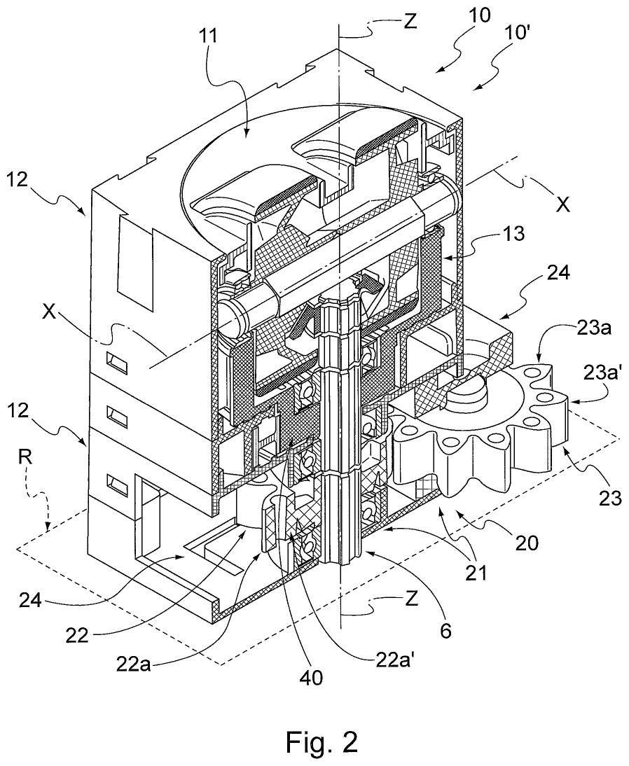

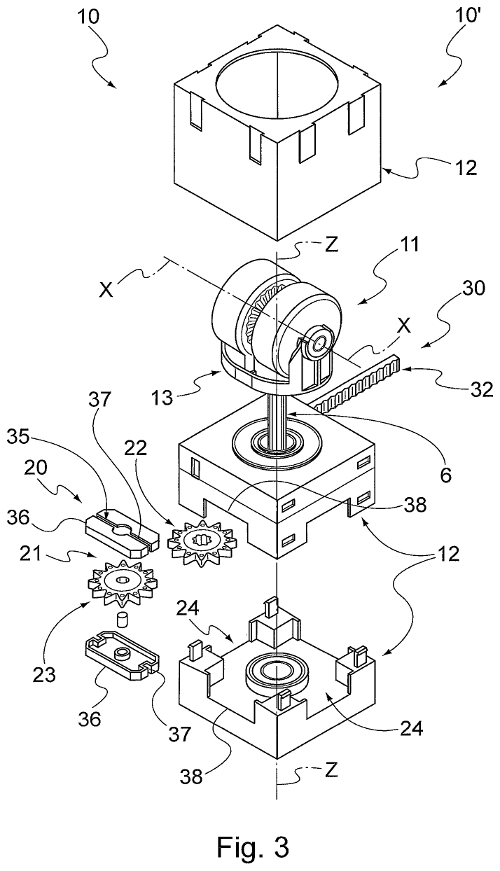

Referring now to the structure, schematically shown in the attached FIGS. 2 and 3, of the orienting units 10, 10′, each of them comprises at least one actuating member 20 to actuate the rotation of at least the transporting element 11 in order to control the rotation thereof around the aforesaid rotation axis X, and at least one drive shaft 6 arranged according to the direction of the vertical axis Z.

The actuating member 20 is designed to modulate the speed and/or gear ratio of the rotation around the axis X of one or more transporting elements 11 of respective adjacent orienting units 10′.

According to the present invention, preferably the orienting unit 10 is a driving orienting unit designed to rotate its own rotation axis X and, through the actuating member 20, also rotate the rotation axis X of at least one adjacent orienting unit 10′.

As already defined above, according to the present invention, unless otherwise specified in the course of the present description, adjacent orienting unit 10′ means a unit arranged sideways, to the right and/or left side of a preset orienting unit 10.

According to the invention, in an operative configuration of the system 1, the orienting units are arranged along the transport plane P according to a matrix scheme, the matrix consisting of rows/columns so that each orienting unit 10 has an even and/or odd number of adjacent orienting units 10′.

According to the invention, in a different operative configuration of the system 1, the orienting units 10 are arranged according to a single column and a predetermined number of rows. Preferably, the column-shaped orienting units 10 are marginally arranged with respect to a predominant feed direction of products 100.

According to the inventive concept of the present invention, the actuating member 20 comprises at least one primary transmission element 22, 22′ keyed on the afore mentioned drive shaft 6.

Furthermore, the actuating member comprises at least one planet transmission element 23 designed to be operatively coupled to the primary transmission element 22. According to the inventive concept of the present invention, the actuating member 20 comprises at least two housing seats 24 to house at least one planet transmission element 23. Preferably, there are four housing seats 24 per each actuating member 20/orienting unit 10.

Each housing seat 24 is arranged on a respective side of the orienting unit 10. Preferably, two housing seats 24 are arranged along the primary feed direction F and two housing seats 24 are arranged along a direction perpendicular to the primary feed direction F.

Preferably, the two seats 24 are arranged parallel to a rotation plane R orthogonal to the vertical axis Z.

Advantageously, the planet transmission element 23 is designed to be selectively and reversibly coupled in at least one of the housing seats 24 so as to transmit the rotation motion of the transporting element 11 to a primary transmission element 22′ of an adjacent orienting unit 10′.

In particular, the actuating member 20 is modular so as to allow the selective operation of a predetermined number of adjacent orienting units 10′ while excluding other of them.

In this way, according to the invention, the actuating member 20 is designed to reversibly activate and rotate/stop one or more transporting elements 11 of the predetermined adjacent orienting units 10′.

Considering two adjacent orienting units 10, 10′, a planet transmission element 23 is housed in two adjacent housing seats 24, 24′ to transfer motion from an orientating unit 10 to the adjacent orienting unit 10′. Three further planet transmission elements 23 allow the transmission of the motion to three further adjacent orientation units 10′ arranged on each side of the orienting unit 10.

Iterating the concept through further planet transmission elements 23, it is possible to transmit the motion, preferably simultaneously, in all four directions to an entire plane P of adjacent orientating units 10′.

In this way, it is therefore possible to transmit the motion with a single motor connected to the most central orienting unit 10 to the whole plane P.

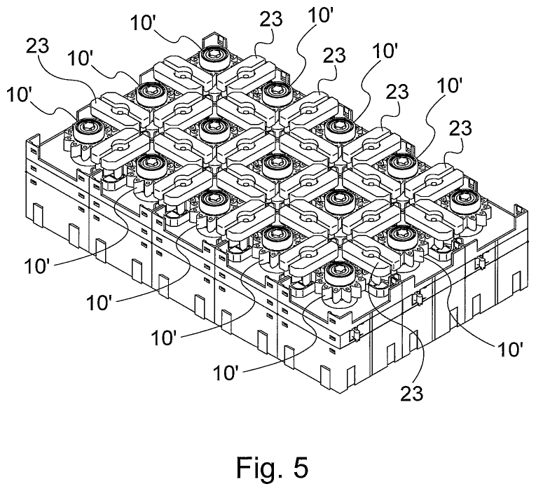

FIG. 5 shows a plane P consisting of a plurality of orienting units 10, 10′, specifically fifteen orientation units 10, 10′, through the planet transmission elements 23 the motion is transmitted by the most central orienting unit 10 to all the adjacent orienting units 10′ forming the plane P. It will therefore be possible to connect the most central orienting unit 10 to a single motor to transfer the motion to the remaining fourteen orienting unit 10′.

Referring to the accompanying FIG. 2, the actuating member 20 comprises a gear assembly 21 for the primary transmission element 22 and the planet transmission element 23, as schematically depicted in the attached FIG. 2.

The gear assembly 21 is operatively combined between the orienting unit 10 and respective adjacent orienting units 10′.

The primary transmission element 22 further comprises at least one primary gear 22a while the planet transmission element 23 comprises at least one planet gear 23a.

Preferably, the gear assembly 21 of the drive member 20 comprises at least a planet gear 23a per each adjacent orienting unit 10′.

Each planet gear 23a is rotatably mounted to a support element 35, consisting of two plates 36 opposed to the planet gear 23a.

Each plate has a groove 37 configured to house two walls 38 of two box-like structures 12 of two adjacent orienting units 10, 10′ so as to hold together two adjacent orienting units 10, 10′.

By the support elements 35 it is possible to hold together all the orienting units 10, 10′ which constitute a plane P or table simply for interlocking the walls 38 in the grooves 37 without requiring further fixing means and/or tools.

According to the inventive concept of the present invention, the planet gear 23a is operatively combined with the primary gear 22a of an orienting unit 10 and designed to mesh with a respective planet gear 23a′ of an adjacent orienting unit 10′ so as to mechanically connect the drive shaft 6 of the orienting unit 10 to the drive shaft 6′ of the adjacent unit 10′.

In other words, an adjacent orienting unit 10′ is moved by a preset orienting unit 10 by means of the gear assembly 21 which allows mechanical and power coupling between the preset unit 10 and precisely one or more adjacent units 10′.

In particular, referring to the attached FIG. 2, the gears 22a, 23a, 22a′ and 23a′ of the gear assembly 21 are housed at least partially inside a box-like structure 12 of the orienting unit 10, 10′ and are operatively arranged parallel to the rotation plane R.

Preferably, the gears 22a, 23a, 22a′, 23a′ of the gear assembly 21 each lie on their own rotation plane not shown in the attached FIGS. 1-4. Even more preferably, the rotation plane 22a, 23a, 22a′, 23a′ of each gear is parallel to the rotation plane R schematically shown in the attached FIG. 2.

According to the invention, the orientation system 1 comprises movement means 30 designed to rotate in a controlled manner the rotation axis X of one or more orienting units of the system 1 itself.

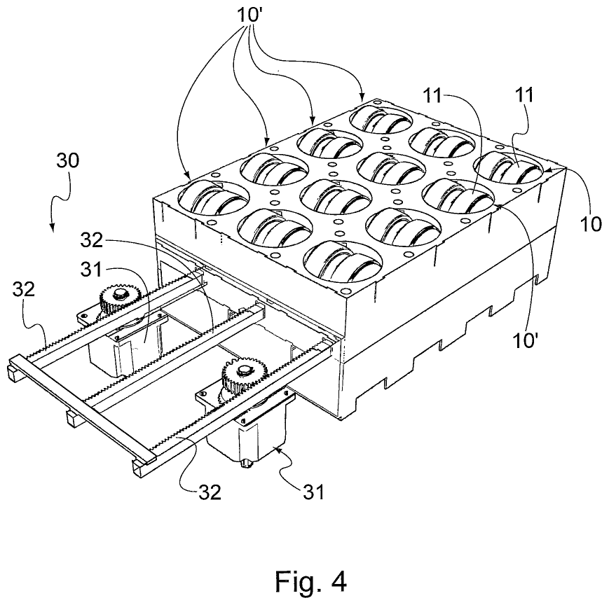

In particular, referring to the attached FIG. 4, the movement means 30 comprise at least one electric motor 31 and a rack system 32 for transmitting the rotation movement of the motor 31 to a sleeve element 40 operatively combined with the drive shaft 6 of each orienting unit 10.

In greater detail, preferably, the sleeve element 40 is operatively combined with a supporting element 13 of the transporting element 11 so as to determine the angular orientation of the axis X with respect to the vertical axis Z.

The present invention has achieved the predetermined purposes.

Advantageously, the present invention relates to an orientation system for product conveyors having both its own dimensions and the overall dimensions of its components as compact and reduced as possible.

Advantageously, the reduced dimensions of the system allow in practice an optimization of the conveyor which can therefore be modular, tailored and also made according to compact dimensions which, at the state of the art, have not yet been achieved due to the space taken up by traditional orientation system to orient the products they transport.

Advantageously, the orientation system for product conveyors of the present invention has high modularity, to be interpreted as the ability to manage different types of products, whilst having the same basic structure and configuration of the system itself. In fact, the system of the present invention is designed to trace new and better trajectories of the feed directions with respect to the orientation systems of known type.

What is claimed is:

1. An orientation system for conveyors of products designed to divert said products from a primary feed direction to a secondary feed direction, the orientation system comprising:
a plurality of orienting units arranged adjacent so as to form a plane for transporting said products, each orienting unit comprising at least one transporting element rotatable around a rotation axis that can be oriented with respect to a vertical axis orthogonal to said primary feed direction and to said rotation axis itself, each orienting units comprising at least one actuating member to actuate a rotation of said at least one transporting element to control the rotation of said at least one transporting element around said rotation axis and at least one drive shaft arranged according to said vertical axis (Z);
wherein said actuating member comprises:
at least one primary transmission element keyed on said drive shaft;
at least one planet transmission element designed to be operatively coupled to said primary transmission element;
at least two housing seats for at least one planet transmission element; and
wherein said planet transmission element is configured to be selectively and reversibly coupled in at least one of said housing seats so as to transmit the rotation of said at least one transporting element to a primary transmission element of an adjacent orienting unit.

2. The orientation system of claim 1, wherein a first orienting unit of the plurality of orienting units is a driving orienting unit designed to rotate its own rotation axis and, through said actuating member, also rotate a rotation axis of a second orienting unit that is adjacent to the first orienting unit.

3. The orientation system of claim 1, wherein said at least one actuating member is modular so as to allow selective actuation of a predetermined number of adjacent orienting units, said actuating member being designed to reversibly activate and rotate or stop one or more transporting elements of said predetermined adjacent orienting units.

4. The orientation system of claim 1, wherein said actuating member comprises a gear assembly for said primary transmission element and said planet transmission element, said gear assembly being operatively combined between said orienting unit and respective adjacent orienting units, said primary transmission element comprising at least one primary gear and said planet transmission element comprising at least one planet gear.

5. The orientation system of claim 4, wherein said planet gear is operatively combined with said primary gear of an orienting unit and designed to mesh with a respective planet gear of an adjacent orienting unit so as to mechanically connect said drive shaft of the orienting unit to the drive shaft of said adjacent unit.

6. The orientation system of claim 4, wherein said two seats are arranged parallel to a rotation plane orthogonal to said vertical axis.

7. The orientation system of claim 6, wherein said gear assembly of said actuating member comprises a planet gear per each adjacent orienting unit.

8. The orientation system of claim 7, wherein each planet gear is rotatably mounted to a support element, comprising two plates opposed to the planet gear; each plate having a groove configured to house two walls of two box-like structures of two adjacent orienting units so as to hold together the two adjacent orienting units.

9. The orientation system of claim 6, wherein said gears of said gear assembly are housed at least partially inside a box-like structure of said orienting unit and are operatively arranged parallel to said rotation plane.

10. The orientation system of claim 6, wherein said gears of said gear assembly each lie on their own rotation plane, each corresponding rotation plane of each gear being parallel to said rotation plane.

11. The orientation system of claim 1, comprising movement means designed to rotate in a controlled manner the rotation axis of the one or more orienting units.

12. The orientation system of claim 11, wherein said movement means comprise at least one electric motor and one rack system for transmitting the rotation movement of said motor to a sleeve element operatively combined with said drive shaft of each orienting unit.

13. The orientation system of claim 12, wherein said sleeve element is operatively combined with a supporting element of said at least one transporting element so as to determine an angular orientation of said rotation axis with respect to said vertical axis.

14. The orientation system of claim 1, wherein said actuating member is designed to modulate a speeder or a gear ratio of the rotation around said rotation axis of one or more transporting elements of respective adjacent orienting units.

15. The orientation system of claim 1, comprising a plurality of orienting units arranged along said transport plane according to a matrix scheme, the matrix comprising rows and columns so that each orienting unit has an even or odd number of adjacent orienting units.

16. The orientation system of claim 15, wherein said orienting units are arranged according to a single column and a predetermined number of rows, wherein said column-shaped orienting units are arranged marginally with respect to a predominant feed direction of products.

17. The orientation system of claim 1, wherein there are four of said housing seats.

18. The orientation system of claim 1, in which each housing seat is arranged on a respective side of said orienting unit, wherein two housing seats are arranged along said primary feed direction and two housing seats being disposed along a direction perpendicular to said primary feed direction.
